(19) United States
(12) Patent Application Publication
(10) Pub. No.: US 2017/0238469 A1
(43) Pub. Date: Aug. 24, 2017

(54) Mechanical Phragmites Non-Chemical Rain Collection Invasive Plant Species Biologic Activation Removal Method

(71) Applicant: June Kessler, Flanders, NY (US)

(72) Inventor: June Kessler, Flanders, NY (US)

(21) Appl. No.: 15/049,864

(22) Filed: Feb. 22, 2016

(51) Int. Cl. A01G 1/00

(52) U.S. Cl. CPC A01G 1/001

(57) ABSTRACT

It is new in the art to mechanically expose Phragmites to continual rain water internal intrusion and retention. Man-made water reservoirs made from the Phragmites living stalk is a new mechanical removal method. Rapid destruction in one season of entire clones occurs with simply one or two cuttings and is effective in any season. Maintaining minimum ⅓ of stalk height leaves the ground shaded and water-logged continually inhibiting seedling growth and causing Phragmites destruction without soil disturbance. Phragmites coding does not have a repair system to overcome mid-section stalk cutting collecting water. It fails to send out new rhizomes as it sends new suckers from the top ligule instead. A second sucker is easily removed below the ligule and the stalk fails to support it's life and dies. Increased insect and fungal activity from the man-made water-logging Phragmites stalk reservoir further reduces Phragmites function and suppresses seedling growth.

### BACKGROUND OF THE INVENTION

Invasive Plant species are destroying natural ecosystems, estuaries, coastlines and forests worldwide. With modern societies movement from one natural area to another by land, sea and air, seeds and plant material can be moved from one area where they grow naturally to another where they are not native indigenous plants. When in a foreign environment plants can become invasive and destructive to natural habitats. They invade by climbing over, shading, crowding out, twining, suffocating and out-competing with native plants and destroy the natural native vegetation. Phragmites also known as common reeds not only displace natural Eelgrass, they kill mussel beds that are the filters of the sea and are the home of small plant and sea life that is the beginning of the food chain in the sea. As they advance into the sea from the coastline, dead Phragmites reed stalks dump into the water creating excessive wrack plant debris that is not normally occurring. This excessive wrack is a main contributor to nutrient levels rising and cause water temperatures to rise as they rot and decay. When the sea nutrient level becomes too high algae blooms occur to balance the sea life resulting in massive die offs of fish, plants and other animal life.

Saxitoxin is produced by the algae bloom and is toxic to all life except the mussel beds it's trying to preserve. In addition this Phragmites wrack is destructive to coastline integrity as it lays upon native plants. When the tides rise and deposit the Phragmites wrack debris on top of native plants and Eel grass it suffocates and burns the underlying plants. Until now there has been no effective removal method for Phragmites common reed for large scale removal in sea areas. If you cut the entire Phragmite stalk it continues to send new rhizome suckers. Chemical removal methods are toxic to fish and wildlife and not appropriate for the water which supports all life. Mowing is not possible in the sea and is not an effective removal method. Rhizome and seedlings continue to appear and mowing must be continued several times year after year as a mechanical control method. Burning is not possible in the sea and in large natural areas with native vegetation as it would burn native vegetation as well destroying the entire ecosystem. In addition it has to be continually repeated to disable the root stores. It would also be a fire hazard and kill the valuable Eelgrass and mussel beds which would be counterproductive. Laying of plastic is not possible in mixed native and invasive habitat areas as the native plants would be suffocated. It is also not effective to place plastic in an entire sea coastline in the water as tides would disturb the plastic if the invasive has entered into the sea and also smother valuable shellfish in the mudflats.

After 18 years of study and trials my rain collection method has proven to be an astounding new advancement in invasive plant species management and may be effective for all reed type plants such as Japanese Knotweed in addition to Phragmites. The invention is intended to be used on a large scale with no negative impact on natural native environments. The invention makes obsolete the use of chemical herbicides for invasive plant reeds removal such as the current use of Glyphosate for Phragmites removal. Rain collection Phragmites removal method is gentle and non-toxic for marine and forest environments. It is a cost effective, rapid plant removal system suitable for any worldwide environment of land or sea. This invention is a planned human interruption and circumvention of the naturally occurring growth patterns, growth signals and repair planning signals planned for in the Phragmites common reed plant's cell structure and DNA. Creating a man-made water reservoir from the Phragmites reed stalk to continually water-log itself and seedlings and activate beneficial destructive biological activity from this man-made creation makes chemical and introduction of biological agents obsolete for Phragmites and other invasive reeds.

### BRIEF SUMMARY OF THE INVENTION

Rain water collection mechanical Phragmites invasive species removal method is a rapid, planned, incremental, mechanical cutting of Phragmites plant reed to disturb growth and create water-logging. A first cut is made below the ligule of the first leaf growing closest to the ground maintaining at least ⅓ of stalk height and interrupts the plants planned growth. As the plant has many ligules remaining it will send a new reed sucker at the top ligule to continue growing and will seal itself off at the top ligule to keep rainwater out from the damaged stalk. A second cutting is taken below the sealed ligule after the reed sucker emerges and grows for a few days or week. As water collects from rain into the open stalk biological activity is activated by the fresh water reservoir in the stalk. Insect activity increases and leaf eating beetles, borers, spiders and other insects emerge onto the scene to feast on damaged leaves, sip from the stalks, borers lay eggs into the open stalk and all further taxes the growth of the Phragmites. Spider webs mechanically bind new suckers as insects feast on them. Rainwater continually collects in the open stalks and works its way to the bottom and continually water-logs the rhizome. The stalks hold the water and it starts to fill. The Phragmites fails to repair the ongoing problems and does not send new root suckers or new rhizomes. Fungus emerges in abundance and further decays the standing stalks as the Phragmites die. Removed stalks are dropped to the ground to act as a mulch to prohibit Phragmites seedling growth on land where no chance of entering the water from tidal surges exist and to not move invasive plant material to new areas. The moist ground gradually returns to native habitat as the Phragmites decompose. No more wrack is dumped into the sea and the sea returns to normal nutrient levels rapidly. Several feet deep in some areas, excess Phragmites wrack preserved in the mud flats begins to be eliminated by sea organisms providing a more solid mud flat for proper holding of eelgrass roots. Excess Phragmites wrack in the mud flats causes a jelly like soft base where mussel beds and eelgrass can easily shake free and die as they turn over in rough tidal currents. Eelgrass grows larger with the surge in nutrients due to Phragmites dumping of dead stalks and the new lack of floating wrack to suffocate them. Mussels increase their growth into the expanding eelgrass beds as this is their home. The Phragmites are destroyed in place by internal flooding and the ecosystem is restored. Native plants repopulate from surrounding areas or can be reintroduced if natural habitat has already been destroyed in the area from human inaction.

### BRIEF DESCRIPTION OF THE SEVERAL VIEWS OF THE DRAWINGS

FIG. 1 is a Phragmites reed showing a first cutting at Position 10 under the ligule and first leaf production. The top portion of the reed with remaining leaves is dropped to the ground on land or removed to adjacent land if the Phragmites reed has grown into the water. Rain water begins to seep into the stalk and settles and collects at position 20.

FIG. 2 is a cut Phragmites reed showing the exposed cut top with a new reed sucker emerging from the top ligule. A second cutting is taken at position 10 below the top ligule. Rain water continues to collect into the reed stalk and settles down to position 20.

FIG. 3 is a wintered Phragmites stalk that has dropped its Leaves and has sealed itself at the tip to keep rain water out of the stalk. A cutting is taken at ⅓ or more of stalk height remaining and just under the ligule shown at position 10. Rain water or snow, depending on weather and area, collect into the stalk and settle into position 20.

FIG. 4 shows young Phragmites reeds 40 mixed with Eelgrass 15 where cutting would be difficult without damaging the native Eelgrass. In this situation preservation of the Eelgrass is desired. As the Phragmites stalks are brittle and the Eelgrass are supple it is recommended to fold both together. The Phragmites 40 will break and the Eelgrass 15 will bounce back unharmed. It is beneficial to maintain at least ⅓ of Phragmites stalk height and leave the bent over reeds to die. FIG. 5 After the young Phragmites reeds dry amongst the Eelgrass 15 which are still green you can use your hand to grab the dried stalks of the Phragmites to reveal an opening for rain water collection shown by position 30.

### DETAILED DESCRIPTION OF THE INVENTION

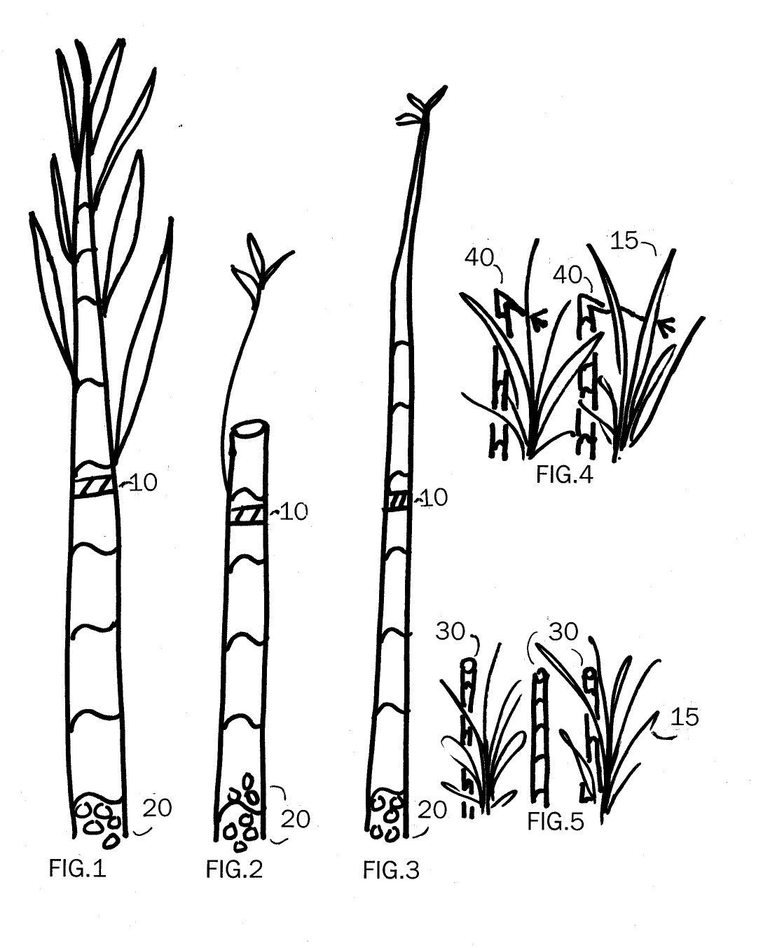

Specific advantages of the present invention are described herein below. The invention is a mechanical removal method suitable for large scale Phragmites invasive species removal projects. The invention is specifically beneficial as it is a cost effective rapid destruction method of entire Phragmites stands. There is no present removal methods for large or small partially degraded estuarine and sea water bodies with mixed native and invasive plant species as this invention. This invention is new in the art for rapid removal and destruction of Phragmites that are growing in water. The invention is new in the art and can be used in mixed habitat environments with native plant and invasive Phragmites species with no harm to native habitat. This invention is effective for Phragmites invasions of both land and sea and where the Phragmites reeds are mixed and intermingled with native Eelgrass and mussel beds. The invention is new in the art to create a man-made water reservoir out of a plant to force biologic activity and water-logging from rainfall to cause complete plant failure and disable natural growth repair plant systems for the Phragmites common reed. The present invention is particularly designed for sensitive water areas. Entire stands can be disabled with two consecutive cuttings. FIG. 1 of the invention shows a single Phragmites reed. An entire stand can be cut with a mechanical rotary cutter at position 10 below the first leaf emanating from the ligule on each Phragmites reed. Rain water will begin to enter the stalks and collect at position 20. As the rain water collects it begins to water-log the rhizome and over time destroys the entire reed. In water bodies several reeds can be tied together, cut in one sweep and removed to land. Hand cutting is also useful when engaging homeowners or citizens for help with maximum environmental stewardship. FIG. 2 is the second cutting of the open stalk after a new sucker has emerged from the top ligule. It is beneficial to use a rotary cutter to reopen all the stalks even if they have not suckered to remove the top ligule that may have sealed itself to keep rain water out. Again you cut at position 10 of FIG. 2 below the top ligule to reopen the stalk for rain collection and remove the reed sucker to stress the plants ability to function. Water will continue to collect at position 20.

FIG. 3 is a winter stalk that has dropped its leaves and has sealed itself at the tip to prevent rain water from entering the stalk. Cutting the stalk at position 10 exposes the stalk to rain and or snow in the winter which will water-log the reed and collect at position 20. It is beneficial on land to allow the cut stalk debris to fall in place. This is economic and also advantageous. The cut stalks act as mulch inhibiting new Phragmites seeds to grow. It also eliminates any risk of moving the plant material to new areas thereby destroying the entire stand. There is no soil disturbance which further protects from seedlings taking root.

FIG. 4 addresses young Phragmites reed mixed with Eelgrass. Left untouched eventually they will overcome the Eelgrass and kill them by shading, dominating the soil with their larger rhizome and raising the soil higher that the Eelgrass. The Eelgrass roots are lifted out of the mudflats by the larger and higher Phragmite rhizome. The underlying mussels die as the Eelgrass is eliminated. Mussels do not remain at the base of Phragmites Invasive reeds as over time they disappear. Where the two are mixed an easy folding of both Eelgrass 15 and young Phragmites 40 together is effective as the Phragmites reeds are brittle and fold while the Eelgrass springs back up unharmed.

FIG. 5 further illustrates the open Phragmites reeds 30 after the dried tops have been pulled off. It is quite easy as they are light and brittle and can be removed in clumps or bunches at a time. The Eelgrass 15 are left to continue growing and can retake the area back from the Phragmites advancement. The Phragmites 30 are now open for rain collection and the plant dies. Eelgrass has prolific seeding which will circulate in the water bodies and re-establish plants easily once the Phragmites are disabled. Phragmites wrack that floats to shore should be monitored for removal as it appears until all of the surrounding areas have been eradicated of the Phragmites reeds. It can me moved to land and used as mulch around the disabled Phragmites reeds. Elimination of Phragmites reeds in water areas has been a difficult task until this invention. History has shown that entire coastlines and native habitat, Eelgrass and mussel beds have been eliminated by Phragmites invasive common reeds due to inaction and the resulting increasing nutrient loading from Phragmites wrack is causing a rise in hypoxic coastal events from algae bloom. Cutting to the ground by mowing, cutting or burning is ineffective as the Phragmites make new rhizomes in their large stand to continue growing and do so continually. Laying of plastic is not possible where there is native habitat and wildlife as it would suffocate and kill everything. Plastic is not an option as it rots everything underneath and thereafter exposes the soil to new invasions as all protective natural grasses would be also eliminated, sea life suffocated and cause disturbance to birds and wildlife. This invention is suitable for land and coastal removals. Vehicles, wind, boats, animals and humans, etc can bring seedlings to coastal areas where it is the most destructive therefore it is important to eradicate Phragmites from all areas in which it is non-native. This invention circumvents programming of the Phragmites reed repair systems to facilitate a rapid failure in the entire Phragmites stand invading on either land, sea, or Eelgrass beds. The rapid implementation, easy operation, non-chemical eco-friendly nature of this invention advances ecological protection to new manageable heights and can be implemented in any large scale global situation. It is rapidly successful in partially degraded areas where native plants seeds and mussels are still present and with the lack of chemical usage native vegetation can repopulate the area cost effectively and quickly from surrounding areas as nature transports new seeds by tides, wind, animal hitch-hiking and in animal defecation. In totally degraded areas where the natural ecosystem has been eliminated it can be implemented rapidly to stop nutrient loading from yearly Phragmites wrack dumping into water bodies. Elimination of algae blooms will also result as the native habitat is restored and the Phragmites wrack dumping stopped. The destruction of global coastlines from Phragmites advancement has been overlooked and ignored. Until this invention there has been no effective non-chemical removal solutions for large scale Phragmites invasions in coastal water removal operations where native habitat is intermixed with the destructive Phragmites common reed. This invention is the first actionable technology to solve the Phragmites invasion in coastal regions in the wide and vast areas necessary to remove all of the invasive plants. Increase of algae blooms and the resulting hypoxic events are undeniable. The inventor has discovered that Phragmites wrack is one of the main contributors to nutrient overloading in water bodies leading to these events where they are present. This invention is the answer as it will rapidly reverse the current Increasing disastrous condition while there's still time. Efficacy of this invention and its scientific statements has been documented with 18 years of research by the inventor. Efficacy has been shown in repeated trials of complete destruction as described. Rapid implementation of this Invention is critical to preserving natural habitat for future generations and water quality for all life itself.

I claim:

1. A mechanical removal method of cutting Phragmites plant reeds below the ligule of the first leaf closest to the ground maintaining ⅓ or more of stalk height. A second cutting below the ligule of the first Phragmite reed sucker or if no sucker is produced a second cutting below the top remaining ligule at the same time reed suckers are cut on adjacent reeds maintaining as much reed height as possible.

2. A mechanical removal method of folding Phragmites plant reeds below the ligule of the first leaf closest to the ground maintaining ⅓ or more of stalk height. A second cutting below the ligule of the first Phragmite reed sucker maintaining as much reed height as possible or if there is no sucker produced a second cutting to open the stalk for rain collection at the top ligule closest to the fold intersection maintaining as much reed height as possible.
